(19) United States
(12) Patent Application Publication
(10) Pub. No.: US 2023/0267338 A1
(43) Pub. Date: Aug. 24, 2023

(54) KEYWORD BASED OPEN INFORMATION EXTRACTION FOR FACT-RELEVANT KNOWLEDGE GRAPH CREATION AND LINK PREDICTION

(71) Applicant: NEC Laboratories Europe GmbH, Heidelberg (DE)

(72) Inventors: Bhushan Kotnis, Heidelberg (DE); Kiril Gashteovski, Heidelberg (DE); Carolin Lawrence, Heidelberg (DE)

(21) Appl. No.: 17/734,129

(22) Filed: May 2, 2022

Related U.S. Application Data
(60) Provisional application No. 63/311,462, filed on Feb. 18, 2022.

(51) Int. Cl. G06N 5/02; G06K 9/62

(52) U.S. Cl. CPC G06N 5/02; G06K 9/6232; G06K 9/6253; G06K 9/6296

(57) ABSTRACT

A method for automated decision making in an artificial intelligence task by fact-relevant open information extraction and knowledge graph generation includes obtaining a keyword query for performing the fact-relevant open information extraction and expanding the keyword query using keyword alias and query generation. The fact-relevant open information extraction is performed to extract triples from a text which contains the keyword or the keyword alias. The knowledge graph is generated using the extracted triples and an open knowledge graph (OpenKG) extractor that has been trained using keywords and aliases. Supervised or unsupervised classification is performed using the generated knowledge graph to make the automated decision in the artificial intelligence task.

### CROSS-REFERENCE TO PRIOR APPLICATION

Priority is claimed to U.S. Patent Application No. 63/311,462, filed on Feb. 18, 2022, the entire disclosure of which is hereby incorporated by reference herein.

### FIELD

The present invention relates to Artificial Intelligence (AI) and Machine Learning (ML) and, in particular, to a method, system and computer-readable medium for keyword based open information extraction for knowledge graph creation and link prediction.

### BACKGROUND

Every day large amounts of text are produced and it is impossible for humans to keep up with this flood of information. Automatically extracting relevant information from these large amounts of data has become a highly relevant prospect. The extracted information can be organized into knowledge graphs and used in AI applications for prediction tasks or automated decision making.

### SUMMARY

In an embodiment, the present invention provides a method for automated decision making in an artificial intelligence task by fact-relevant open information extraction and knowledge graph generation. A keyword query is obtained for performing the fact-relevant open information extraction. The keyword query is expanded using keyword alias and query generation. The fact-relevant open information extraction is performed to extract triples from a text which contains the keyword or the keyword alias. The knowledge graph is generated using the extracted triples and an open knowledge graph (OpenKG) extractor that has been trained using keywords and aliases. Supervised or unsupervised classification is performed using the generated knowledge graph to make the automated decision in the artificial intelligence task.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a method and system for open information extraction and open knowledge graph completion according to an embodiment of the present invention;

FIG. 2 illustrates a query optimization of the query optimization module of FIG. 1 according to an embodiment of the present invention;

FIG. 3 illustrates a fact-relevant text extraction of the open knowledge graph extractor module of FIG. 1 according to an embodiment of the present invention; and

FIG. 4 illustrates a pruning and classification of the open knowledge graph pruning and classification module of FIG. 1 according to an embodiment of the present invention.

### DETAILED DESCRIPTION

Embodiments of the present invention provide improvements to open information extraction systems, as well as knowledge graph completion and link prediction systems. Existing technology extracts information that is too general and not necessarily relevant. In contrast, embodiments of the present invention can ensure to extract only information relevant for the problem at hand using keywords and context as constraints. This allows the building of a fact-relevant knowledge graph for downstream tasks in a computationally efficient manner. Further, by utilizing such a fact-relevant knowledge graph, embodiments of the present invention allow for improved automated control of technical systems which utilize the knowledge graph for the automated control. In particular, the accuracy of the automated decision making is improved by the fact-relevant knowledge graph providing for better predictions or classifications, while also allowing for faster computing and/or saving computational resources since not all information needs to be extracted, but rather only the relevant information.

Embodiments of the present invention solve the problem of extracting targeted context sensitive information in the form of an open knowledge graph (OpenKG) from text and using this OpenKG for making automated decisions. Existing technology of open information extraction systems are geared towards extracting all possible information from text in the form of triples. However, such existing systems extract information that is unnecessary and then filter out the irrelevant information using post processing. The mechanisms of extraction are not targeted, nor are they context sensitive and therefore they may miss information that is important and make extraction errors due to lack of context. Additionally, such existing systems have no way to prune the extracted knowledge graph for removing erroneous extractions. Embodiments of the present invention address the problem of extracting targeted specific information supplied in the form of keywords and other context information such as location and temporal phrases to build an improved fact-relevant knowledge graph. Embodiments of the present invention also enable the additional feature of pruning the noisy OpenKG and then performing prediction or classification for automated decision making.

Open information extraction (OIE) aims to extract structured facts in the form of (subject, predicate, object) triples from natural language sentences. For example, given a sentence, “Barrack Obama became the US President in the year 2008”, an OIE system is expected to extract the following triples: (Barrack Obama; became; US President) and (Barrack Obama; became US President in; 2008). The subject, predicate and the object of the triple are referred to as slots of a triple.

Existing technology of OIE systems extract all facts from a sentence. In contrast, embodiments of the present invention can instead address how to specifically look for information given some keywords and possible context to create a fact-relevant knowledge graph. By doing so, embodiments of the present invention enable to enhance accuracy in automated technical systems which use the knowledge graph, while also building, maintaining and using the knowledge graph with increased computational efficiency since it is not necessary to extract all facts in a text being used to obtain the more relevant results.

According to a first aspect, the present disclosure provides a method for automated decision making in an artificial intelligence task by fact-relevant open information extraction and knowledge graph generation. A keyword query is obtained for performing the fact-relevant open information extraction. The keyword query is expanded using keyword alias and query generation. The fact-relevant open information extraction is performed to extract triples from a text which contains the keyword or the keyword alias. The knowledge graph is generated using the extracted triples and an open knowledge graph (OpenKG) extractor that has been trained using keywords and aliases. Supervised or unsupervised classification is performed using the generated knowledge graph to make the automated decision in the artificial intelligence task.

According to a second aspect, the present disclosure provides the method according to the first aspect, further comprising obtaining a context query, expanding the context query using context alias and query generation, and performing the fact-relevant open information extraction to extract the triples from the text which contain the context or the context alias, and the keyword or the keyword alias.

According to a third aspect, the present disclosure provides the method according to the first or the second aspect, further comprising displaying the aliases and queries to a user, and updating the aliases and/or the queries based on a user input.

According to a fourth aspect, the present disclosure provides the method according to any of the first to third aspects, further comprising displaying the knowledge graph to a user, and pruning the knowledge graph based on a user input.

According to a fifth aspect, the present disclosure provides the method according to any of the first to fourth aspects, further comprising pruning the generated knowledge graph by at least one of temporal, location or triple pruning.

According to a sixth aspect, the present disclosure provides the method according to any of the first to fifth aspects, wherein the keyword query is obtained from a recommendation system.

According to a seventh aspect, the present disclosure provides the method according to any of the first to sixth aspects, wherein the supervised classification is performed using a Gumbel softmax.

According to an eighth aspect, the present disclosure provides the method according to any of the first to seventh aspects, wherein the unsupervised classification is performed using a relational page rank algorithm.

According to a ninth aspect, the present disclosure provides the method according to any of the first to eighth aspects, wherein the OpenKG extractor has been trained using different keywords and context from a different source text, wherein each of the keywords and the respective context are combined at nodes in the knowledge graph.

According to a tenth aspect, the present disclosure provides the method according to any of the first to ninth aspects, wherein the automated decision includes one of adapting parameters of a device or digital display, or manufacturing or providing instructions for manufacturing of a product.

According to an eleventh aspect, the present disclosure provides a system for automated decision making in an artificial intelligence task by fact-relevant open information extraction and knowledge graph generation. The system comprises one or more hardware processors configured, alone or in combination, to provide for execution of the following steps: obtaining a keyword query for performing the fact-relevant open information extraction; expanding the keyword query using keyword alias and query generation; performing the fact-relevant open information extraction to extract triples from a text which contains the keyword or the keyword alias; generating the knowledge graph using the extracted triples and an open knowledge graph (OpenKG) extractor that has been trained using keywords and aliases; and performing supervised or unsupervised classification using the generated knowledge graph to make the automated decision in the artificial intelligence task.

According to a twelfth aspect, the present disclosure provides the system according to the eleventh aspect, being further configured to obtain a context query, expand the context query using context alias and query generation, and perform the fact-relevant open information extraction to extract the triples from the text which contain the context or the context alias, and the keyword or the keyword alias.

According to a thirteenth aspect, the present disclosure provides the system according to the eleventh or twelfth aspects, wherein the OpenKG extractor has been trained using different keywords and context from a different source text, wherein each of the keywords and the respective context are combined at nodes in the knowledge graph.

According to a fourteenth aspect, the present disclosure provides the system according to any of the eleventh to thirteenth aspects, wherein the automated decision includes one of adapting parameters of a device or digital display, or manufacturing or providing instructions for manufacturing of a product.

According to a fifteenth aspect, the present disclosure provides a tangible, non-transitory computer-readable medium having instructions thereon, which, upon being executed by one or more processors provide for execution of the method according to any of the first to the tenth aspects.

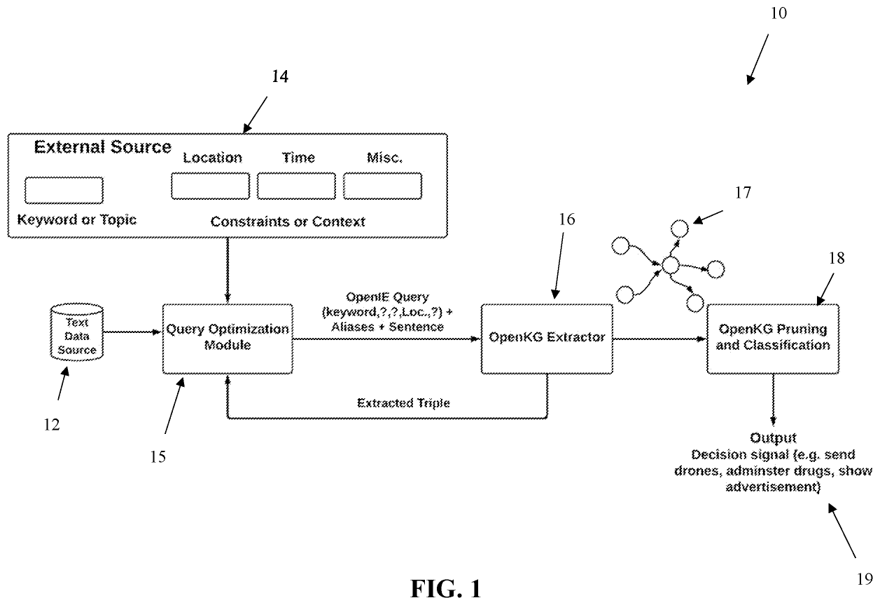

FIG. 1 illustrates a method and system 10 for open information extraction and open knowledge graph completion, as well as an OpenKG pruning and classification system which can further improve the knowledge graph (here, in the form of an OpenKG 17), according to an embodiment of the present invention. The system of FIG. 1 consists of four modules: (1) an external source 14 which acts as an input module; (2) a query optimization module 15; (3) an OpenKG extractor module 16; and (4) an OpenKG pruning and classification module 18. Additionally, the system 10 expects a text data source 12 from which the system extracts the OpenKG 17. To extract relevant information, the external source 14 that acts as the input module can be, for example, a recommender system that provides one or more keywords along with optionally a context such as location, time or anything else which the external source 14 deems relevant. The recommender system can determine keywords and context by analyzing the input text documents. The recommender system itself can have multiple approaches of how to recommend the keywords and their context within the scope of embodiments of the present invention. For example, one approach is to run a part-of-speech (POS) tagger on the input sentences, selecting the top five nouns with the highest term frequency-inverse document frequency (TF-IDF) score and then use them as keywords (e.g., keywords recommendations). Then, the context recommendation could be provided by running spatial/temporal taggers (e.g., HeidelTime for temporal tagging) on the sentences where the keyword appeared, and then selecting the space/time context (if found) that modifies the keyword noun. The query optimization module 15 converts the keyword and the context into queries and sentences from which the OpenKG 17 can be extracted.

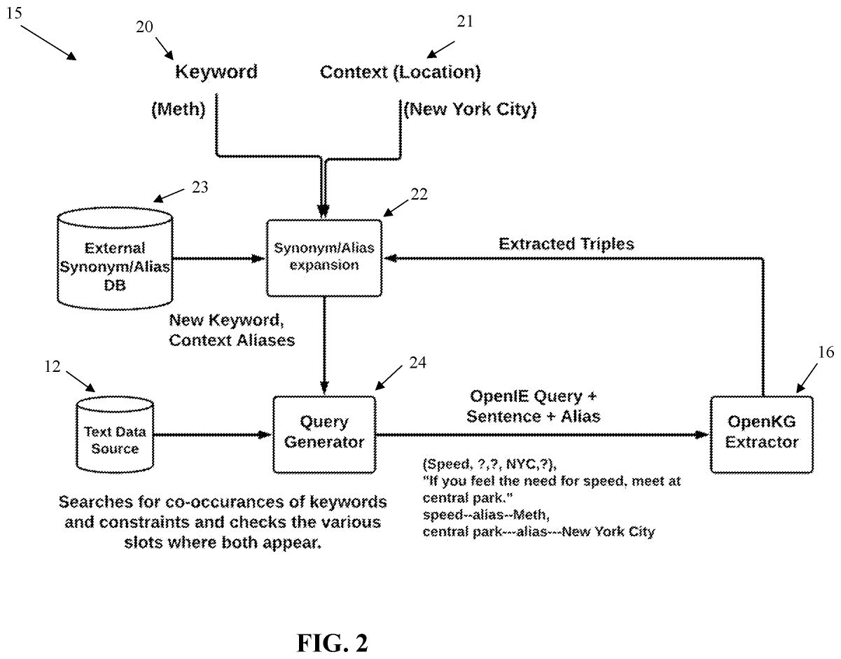

FIG. 2 illustrates an embodiment of the query optimization module 15. Preferably, the first step is to generate aliases. This is useful because the exact keyword 20 may appear in the text with alternative names and identifying related concepts will enrich the extraction. To perform initial synonym and alias expansion for each keyword 20, an external synonym/alias database 23 can be queried, for example by performing one or more of steps: (1) performing a lookup into a paraphrase database (PPDB); or (2) querying a thesaurus of synonyms and populating the initial aliases with the results. Then, a synonym/alias expansion module 22 along with a query generator module 24 can iteratively expand the aliases one by one until a stopping criterion is reached. One example stopping criterion is that a certain number of sentences are obtained. For example, given a keyword 20 and a context 21 which acts as a constraint, the query generator module 24 can search for sentences in the text data source 12 containing either the keyword 20, the context 21, and finally both keyword 20 and the context 21, including any aliases. The keywords are words on which to extend the aliases (e.g., if the keyword is “CEO”, the search or a subsequent search would also include the alias “Chief Executive Officer”). For example, it is possible to first search for the keywords' aliases as part of the step of searching the keywords by querying a database which contains phrases and their aliases (e.g., the PPDB). This way, the scope of possible relevant answers is extended. Preferably, there are two aliases, in particular keyword aliases and context aliases. In the example of FIG. 2, which could be used in an automated incident detection for public safety, the keyword 20 is “Meth” and the context is “New York City” which is a location. The keyword 20 and context 21 can be given by a recommender system (e.g., from predictions on processing of text or preferences), or could be provided by a database or users interested in certain keywords 20 and context 21, such as law enforcement officials in New York City. An example sentence in the text data source 12 could be “[i]f you feel the need for speed meet at central park,” which does not contain the keyword 20 or context 21, but includes aliases of the keyword and context. Here, the context alias for the location New York City can be any place known to be part of the location, as well as other known synonyms/aliases for the location such as “New York, N.Y.,” “NYC” or “the big apple”.

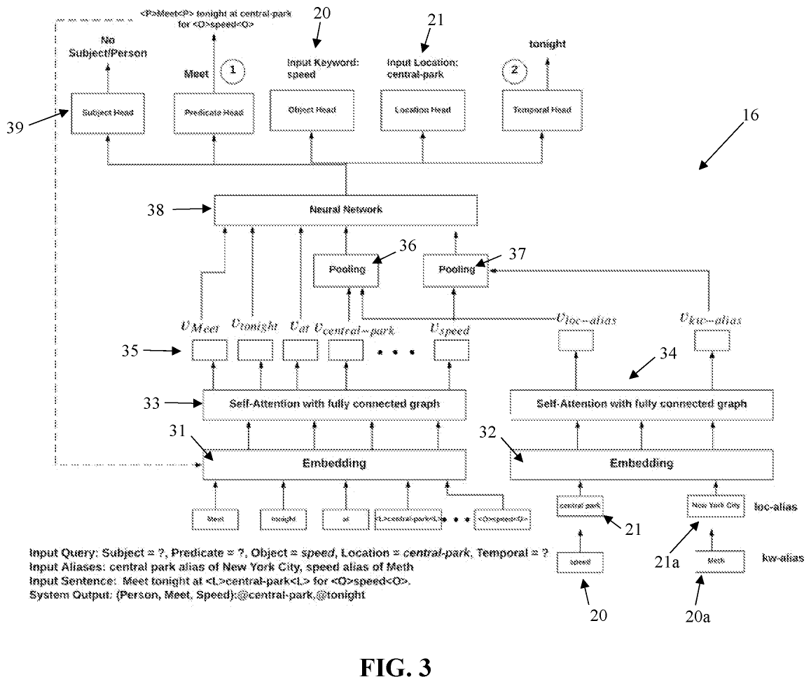

However, it is typically not clear which aliases will give meaningful extractions. To obtain useful aliases and corresponding extractions, an iterative approach is used. An initial synonym/alias expansion of the keyword 20 and the context 21 is obtained by the synonym/alias expansion module 22 from the external synonym/alias database 23, and/or by input from domain experts or knowledge. The query optimization module 15 first searches for sentences using an inverse index on the text of the text data source 12 containing either the keyword alias or the context alias. The inverse index is an inverted index for text retrieval, which is essentially a lookup table in which each entry is a word and the indices of the documents that contain the word (see, e.g., Lin and Dwyer, “Inverted Indexing for Text Retrieval,” Birkbeck, University of London, Chapter 4, pp. 65-86 (Mar. 31, 2018), which is hereby incorporated by reference herein). If no sentences are found, then another alias can be used. If sentences are found, then embodiments automatically identify the slots (subject, object or predicate) for the keyword and context. This can, for example, be done by using a dependency parser to obtain dependency tags from the sentences and assigning certain dependency tags to map to the appropriate slots (subject, object or predicate) of the triples. As shown in FIGS. 2 and 3, there can also be slots for the time and location (e.g., Speed, ?, ?, NYC, ?). Thus, a triple which is an output 39 of the OpenKG extractor module 16 can include slots for the subject head (in the example of FIG. 3, there is no subject), the predicate head (e.g., “meet”), the object head (e.g., the input keyword “speed”), the location head (e.g., the input context “central-park”) and the temporal head (e.g., “tonight”).

Different known dependency parsers can be used in accordance with embodiments of the present invention. Dependency parsing is a rather complex natural language processing (NLP) task, and there are different trained deep learning models which can be used for parsing a sentence (see, e.g., Jurafsky, Daniel, et al., “Dependency Parsing,” Speech and Language Processing, Chapter 14, pp. 1-27 (2021), which is hereby incorporated by reference herein).

The slot information along with the sentences and aliases are passed from the query generator module 24 to the OpenKG extractor module 16. For each sentence containing either a keyword alias or context alias, the entire triple can be extracted. For a sentence marked with a given keyword alias, the missing parts of the triple including location and temporal information can be obtained. Both are checked in an external source, such as the external synonym/alias database 23, to check if they are a synonym of an alias of the provided context 21, which can be location or temporal constraints. The number or count of such extractions indicates the usefulness of the alias. If the extracted temporal or location information is relevant, then the keyword alias is marked as relevant and the most similar keyword alias (e.g., the most similar or closest in the embedding space) is chosen for the next iteration. For example, pretrained embeddings are used. By looking up in an embedding table, the respective vectors as the embeddings for the respective words are determined in an embedding space, which then enables to check how close the embeddings are to each other in the embedding space. A similar procedure is done for a context alias, and the extracted keywords are checked for relevance. The procedure continues until the stopping criterion is reached. Next, to build an OpenKG 17, the missing triple and context parts in a sentence are identified with the OpenKG extractor module 16.

The architecture of an embodiment of an OpenKG extractor module 16 is illustrated in FIG. 3. The OpenKG extractor module 16 has a neural network 38 which is trained to iteratively extract the slots in a triple, preferably using training data from an isolated dataset. The OpenKG extractor module 16 extracts the missing slots by conditioning on the slots associated with the keyword 20 and context 21, and also the keyword aliases 20a and the context aliases 21a. For example, from the sentence in FIG. 3 “Meet tonight at central park for speed,” the OpenKG extractor module 16 will extract the timing ‘tonight’ and predicate ‘Meet’ conditioned on the keyword ‘speed’ which appears as the object and ‘central park’ as location. Embodiments can also use the alias information to augment the keyword present in the sentence using the neural network 38. This ensures that the extraction is also applicable not just for the keyword present in the sentence, but also for aliases of the keyword. This comes from the observation that, if a word is replaced by the synonym, then the extractions should not change.

For training the model, standard backpropagation-based strategies can be used for learning the parameters of the architecture. At prediction time, or in a use phase, one does a forward pass of the input sentence through the architecture (with its learned parameters) shown in FIG. 3, which produces the extractions. Thus, the OpenKG extractor module 16 extracts OIE extractions from text. The final OpenKG 17 is one graph. In subsequent steps, a knowledge graph embedding model is trained on the OpenKG 17 (here, the OpenKG 17 is a standard canonical knowledge graph). After all fact-relevant triples are extracted from the available sentences, these can be arranged in a knowledge graph. In the knowledge graph, alias keywords and contexts will have one joint node representation (each keyword and its context, and the aliases, are merged into one node in the knowledge graph). This directly links equivalent entities, but with different surface strings, together. Surface strings refer to the original strings (mentions) referring to a concept. For example, one can have the surface strings “NY”, “New York” and “NYC”, which all refer to one concept—New York City.

The architecture of the OpenKG extractor module 16 can be based on a transformer model (see, e.g., Ashish Aswani, “Attention Is All You Need,” 31^{st} Conference on Neural Information Processing (NIPS 2018), Long Beach, Calif., USA, arXiv:1706.03762 (Dec. 6, 2017), which is hereby incorporated by reference herein). The architecture includes embedding functions 31, 32 for the input sentence and keyword 20 and context 21 and aliases 20a, 21a, and respective self-attention functions with a fully connected graph 33,34, which output respective vector embeddings 35. Pooling functions 36, 37 can also be provided before inputting the vector embeddings 35 into the neural network 38, which outputs the extracted triples, including a subject head, predicate head and temporal head, where available, for the fact-relevant knowledge graph. There are various pooling methods which could be applied. For example, one function for pooling would be to perform a, average of the inputs, which is also referred to as mean pooling. Another function for pooling would be to compute the maximums across each dimension of the vector, which is also referred to as max pooling.

Overall, although fact relevant rather than a general extraction, this knowledge graph could still contain some irrelevant triples. Therefore a series of pruning steps may be applied.

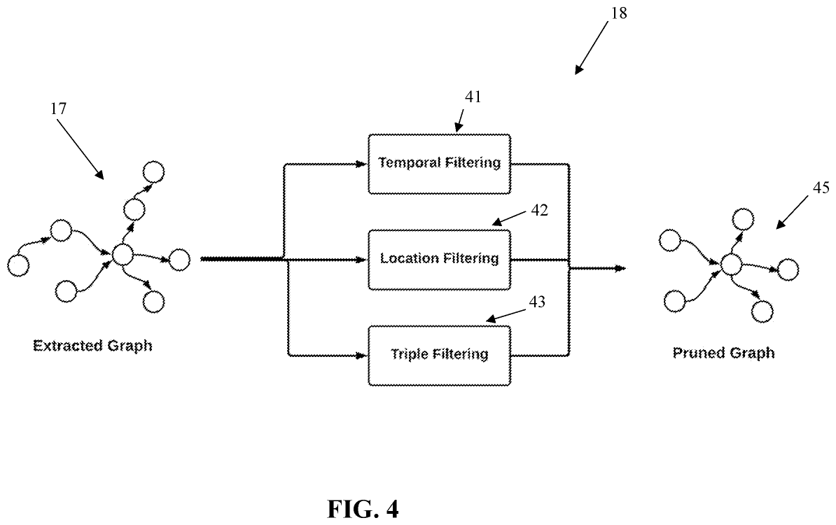

The OpenKG pruning and classification module 18 shown in FIG. 4 performs pruning on the extracted OpenKG 17 and uses the pruned OpenKG 45 for classification or prediction. For pruning, it is possible that the extracted OpenKG 17 may consist of either erroneous extractions or irrelevant extractions. The OpenKG pruning and classification module 18 can filter triples that are irrelevant and/or error prone. The OpenKG pruning and classification module 18 in the embodiment illustrated in FIG. 4 consists of three subsystems: (1) a temporal filtering subsystem 41, (2) a location filtering subsystem 42, and (3) a triple filtering subsystem 43. For temporal filtering, in the case where the temporal context is not provided and needs to be extracted, it is possible that triples extracted with temporal information are either incorrect or irrelevant. For location filtering, if locations need to be extracted, then location filtering is performed for filtering out erroneous and irrelevant locations. For triple filtering, the triples extracted from the document are related to the keyword, though it is possible that correct triples are extracted, but are not relevant to the theme or the keyword. The triple filtering system 43 filters out such triples.

The temporal filtering can be carried out in accordance with the following pseudocode:

1. Check if temporal context is provided for extracted triple.
2. IF temporal context is missing, THEN filter the triple.

### 3. ELSE:

3.1. IF: extracted temporal context does not match the required temporal context, THEN filter the triple.

The location filtering can be carried out in accordance with the following pseudocode:

1. Check if location context is provided for extracted triple.
2. IF location context is missing, THEN filter the triple.

### 3. ELSE:

3.1. IF: extracted location context does not match the required location context, THEN filter the triple.

The triple filtering can be carried out in accordance with the following pseudocode:

1. IF: keyword matches at least one slot in the extracted triple, THEN: do not filter.
2. ELSE: filter triple.

The extracted OpenKG 17 consists of sets of triples, as does the pruned OpenKG 45. The nodes in the knowledge graph represent subjects and objects, and the relations are the predicates. Temporal and location information can also represented as nodes in the knowledge graph. The temporal/spatial nodes are related with temporal/spatial relations. These can be prepositions (e.g., “in”, “from”, “to”, etc.) or verb phrases (e.g., “was born in 1956 in”). The nodes and relations are phrases expressed in natural language. An example structure of a knowledge graph is shown in FIG. 4 of US 2020/0065668, which is hereby incorporated by reference herein in its entirety). In applications where a particular link prediction task is defined and training data is available, a supervised classification algorithm can be used for classification or link prediction. If there is a lack of training data, an unsupervised method can be used instead. However, other classification approaches are also possible.

For supervised classification, all the elements of the triple are converted to embeddings using a pretrained model. Using, for example, a Gumbel softmax the relations are mapped to a fixed number of centroids and used in a knowledge graph embedding model (e.g., DistMult) to train and predict whether the keyword has a specified relation with the context, e.g., ‘Meth’->(Active Drug Deal)->‘central-park’. Using the Gumbel softmax, the relation embedding (d dimensional vector) is provided as an input to the Gumbel softmax function along with the k-centroids. The Gumbel softmax function outputs a k-dimensional probability vector which is then used for choosing the i^{th} centroid from k. This centroid is then used in a knowledge graph embedding model such as DistMult or ComplEX. A Gumbel softmax distribution is described, e.g., by Emma Benjaminson, “The Gumbel-Softmax Distribution,”<<https://sassafras13.github.io/GumbelSoftmax/>>, online (Aug. 13, 2020), which is hereby incorporated by reference herein.

For unsupervised classification, all the elements of the triple are converted to embeddings using a pretrained model, and knowledge graph embedding models (e.g., TransE) are then trained on the OpenKG 17 or 45. Then, a page rank algorithm is run starting from all keyword aliases. The page rank jumping probability is obtained by using the similarity of the object with the embedding vector obtained from adding the subject and relation embedding. All the context aliases (for example, for locations) are ranked using the page rank algorithm. If the strength of the highest ranked context is greater than a threshold, then a positive decision is sent to an automated system.

Embodiments of the present invention can be practically applied to effect improvements in automated AI systems (for example, in prediction or classification systems) and in many fields of technology which employ automated AI systems for automated decision making.

For example, embodiments can apply to automated health systems, e.g., for drug production as follows:
Use case: Automatically read published biomedical papers and derive a medical drug.
Data source: The text can be biomedical papers and keywords can include illness name or symptom, known relevant information (such as proteins) as defined by a domain expert.
Method: Application of an embodiment of the method provides that the system creates an alias-enriched and topic-pruned knowledge graph for an illness or system and predicts the components of the new drug.
Output: Components of the new drug and (optionally) the pruned knowledge graph for human verification.
Physical change or technical effect: The output is connected to a machine that can manufacture the drug.

Another embodiment can be practically applied to a public safety system, e.g., for a crime prediction as follows:
Use case: Text generated in different districts is automatically analyzed to predict crime rates.
Data source: The text can be social media and other text on the internet with geo location tags or relevant keywords, and keywords can be district related, trigger words as defined by a domain expert.
Method: Application of an embodiment of the method provides that the system creates an alias-enriched, topic-pruned and time-sensitive knowledge graph for relevant locations and predicts for each location the future crime rate.
Output: Locations where crime rates will likely increase and (optionally) the pruned knowledge graph for human verification.
Physical change or technical effect: Monitoring units can automatically be adapted (e.g., drones, body cams of police), or digital advertising panels can be adapted to fight misinformation.

Another embodiment can be practically applied in material science, e.g., for creating new materials (e.g., a new material for carbon neutrality) as follows:
Use case: Scientific descriptions of materials are parsed to create new materials.
Data source: The text can include written reports about different materials and the keywords can include characteristics important for the goal of the new, to-be-created material.
Method: Application of an embodiment of the method provides that the system creates an alias-enriched and topic-pruned knowledge graph for relevant characteristics and predicts which material components are needed to achieve these characteristics.
Output: Material components to create the new material with desired characteristics.
Physical change or technical effect: Automatic manufacturing of the material, e.g., using a polymer manufacturing system.

Another embodiment can be practically applied to a personalization system, e.g., for dynamic advertisement as follows:
Use case: Advertisement displays are automatically adjusted depending on the user who is currently close to these displays.
Data source: The text can include information about products as provided by the producers of the product and the keywords can be chosen by the customer based on what is important to them when shopping (e.g., low calorie, high protein) or can be extracted from other sources, such as the customer's profile or past purchases.
Method: Application of an embodiment of the method provides that the system creates an alias-enriched and topic-pruned knowledge graph for each user and product and predicts the product a user might be interested in.
Output: Products that the user might be interested in and, preferably, highlighted relevant keywords and (optionally) the pruned knowledge graph for human verification.
Physical change or technical effect: The digital advertisement is automatically adapted.

Another embodiment can be practically applied to a digital government system, e.g., for environmental, social and corporate governance (ESG) score prediction as follows:
Use case: ESG is a way of evaluating how much an organization cares about these three values (i.e., environment and social impact, and corporate governance). Relevant data is analyzed to predict a company's ESG score based on what ESG aspects are important to a user.
Data source: The text include ESG data provided by companies, which is required to be published, and the keywords include ESG aspects important for the user (e.g., lower CO₂ emissions, solar power) as well as a company name(s).
Method: Application of an embodiment of the method provides that the system creates an alias-enriched and topic-pruned knowledge graph for each company with respect to the relevant keywords and predicts the ESG score for each company.
Output: The ESG score for the companies and (optionally) the pruned knowledge graph for human verification.
Physical change or technical effect: Given a list of company names, the company that achieves the highest ESG score can be identified. Based on this, for example, materials can be ordered, products or sub-products manufactured automatically, goods can be transported from one location to another (with focus on CO₂ reduction), and so on.

Embodiments of the present invention enable the following advantages and improvements over existing technology:
Conditioning information extraction on a set of keywords and possible context provided, for example, by a recommendation system (such as time and location), which enables the building of fact-relevant open information extraction and knowledge graph creation.
Iterative alias expansion and query generation by alias scoring for extending the scope of the triple to be extracted which will enrich the knowledge graph.
Using alias information during the OpenKG extraction, which ensures that the extraction is conditioned not just on the word present but also possible aliases.
Supervised and unsupervised classification in connection with the pruned fact-relevant OpenKG using supervised knowledge graph embedding methods involving Gumbel softmax and unsupervised techniques using relational page rank algorithm.
Pruning in combination with the fact-relevant OpenKG for removing irrelevant triples and noise using any combination of location, temporal or triple filtering.

In an embodiment, the present invention provides a keyword based method for extracting relevant facts from text, comprising the steps of:

1) Setting up the system;

a) Expanding the keywords and context using aliases and query generation using training data which is different than the data used later in extracting and using the system;

b) Identifying which triple slots are present in a sentence, e.g. by using a dependency parser;

c) Training the iterative OpenKG extractor module using OpenKG triples along with alias information, where the alias information is fused with the original term that occurs in the text, for example using the synonym/alias expansion module and combining the keywords and context, and their aliases, at nodes in the knowledge graph (each keyword/context provides a node in the knowledge graph;

d) Using the three pruning strategies (location, temporal and triple pruning) for filtering the knowledge graph;

e) Either using the supervised OpenKG classifier or training TransE embedding and performing a page rank using the TransE jump probabilities.

2) Using the system;

a) Obtaining keyword and context queries, which were not used in the training/setting up of the system, (e.g., from a database or a recommendation system) to perform fact-relevant open information extraction;

b) Using alias expansion and query generation, and optionally displaying to users;

c) Optionally, a user may update the aliases as deemed fit and also filter out queries deemed to be irrelevant;

d) Using the trained OpenKG extractor module for obtaining the knowledge graph by extracting sentences containing the keyword/context or aliases;

e) Preferably, at this step, the extracted knowledge graph may be pruned, e.g., by pruning irrelevant locations and time periods or triples;

g) Optionally, displaying graph to user if desired to modify or prune the knowledge graph; and

h) Classifying with the pruned knowledge graph using either the supervised knowledge graph embedding methods or unsupervised page rank-based classification to determine a course of action, e.g., whether to synthesize a particular polymer or not.

Embodiments of the present invention provide many advantages and actual technical improvements compared to existing technologies that extract all facts found. For example, existing systems known in the art do not distinguish between relevant and irrelevant facts. See Kotnis, Bhushan, et al., “Integrating diverse extraction pathways using iterative predictions for Multilingual Open Information Extraction,” arXiv preprint arXiv:2110.08144 (2021), which is hereby incorporated by reference herein. Therefore, the resulting set of extraction by the existing systems will be noisy and not relevant for the downstream task. Embodiments of the present invention instead ensure that only relevant facts are extracted and thereby improve downstream task performance.

Embodiments of the present invention also provide to improve methods and systems for the task of open link prediction (OLP) (see Broscheit, Samuel, et al., “Can We Predict New Facts with Open Knowledge Graph Embeddings? A Benchmark for Open Link Prediction,” ACL: 2296-2308 (2020), which is hereby incorporated by reference herein). The OLP task is as follows: given an input query with mentions (strings) for a subject and relation, predict one of the possible acceptable mentions for the object. Consider, for example, the following query: (“Dustin Hoffman”; “was born in”; ?). An OLP model should predict any acceptable mention about Los Angeles, including “Los Angeles”, “L.A.” or “the city of the angels”. In contrast to embodiments of the present invention, OLP expects the triples to already be extracted and there is no reference to ensuring that triples are relevant.

Embodiments of the present invention also provide to improve methods and systems for OpenKG canonicalization (Vashishth, Shikhar, Prince Jain, Partha P. Talukdar: CESI: Canonicalizing Open Knowledge Bases using Embeddings and Side Information, WWW 2018: 1317-1327 https://dl.acm.org/doi/pdf/10.1145/3178876.3186030, which is hereby incorporated by reference herein). In OpenKGs, which are large datasets of OIE extractions, there are often relations and arguments (subjects and objects) that refer to the same concept. For instance, the relations “was born in” and “has birthplace in”, and the arguments “New York City” and “NYC”, have equivalent meaning respectively, but are represented as different strings. To tackle this, existing technology focused on canonicalizing the slot elements from OIE triples into “relational synsets” and “arguments synsets” respectively. In contrast to such canonicalization methods, embodiments of the present invention do not consider prior OpenIE extractions, but are capable of considering only the raw input text. Moreover, the methods of obtaining synonyms according to the present invention can differ as they may have different goals. For example, embodiments of the present invention can find additional sentences while OpenKG canonicalization is usable merely to identify similar words.

The extension of the synonyms module of embodiments of the present invention are also different from OpenKG canonicalization such as in Vashishth at al., because they do not aim to group the arguments and/or relations into separate synsets by automatically clustering them from prior OIE data. Instead, embodiments of the present invention extend the synonyms by querying external sources, such as a paraphrase database and a thesaurus. Moreover, embodiments of the present invention can automatically extend the relevant synonyms by looking at raw text as input, while OpenKG canonicalization methods require OIE triples as input (i.e., postprocessed text).

Gupta, Swapnil, et al., “CaRe: Open Knowledge Graph Embeddings,” EMNLP/IJCNLP (1): 378-388 (2019), which is hereby incorporated by reference herein, propose CaRe, where they consider canonicalizing arguments and relations as a prior step for learning argument and relation embeddings for the task of link prediction. In contrast to CaRe, embodiments of the present invention do not use OpenKG for training, but raw text. Also, embodiments do not rely on canonicalization steps like in CaRe. Finally, in CaRe the authors do not make use of, e.g. Gumbel softmax, but instead propose implementation with different models such as TransE, TransH, DistMult, ComplEx, R-GCN and ConvE.

Embodiments of the present invention operate on language specific, supervised data. A tool can easily and efficiently annotate such data.

Various technology has been used in extracting information from large amounts of text in various projects. In these projects, the existing technology extracts information that is too general. Embodiments of the present invention address this technical problem and extract more relevant information, which leads to better downstream decisions. For example, for embodiments applied to material science, the present invention can directly help to ensure that the knowledge graph contains truly relevant facts rather than any fact that can be found, as currently existing OIE systems would do. For embodiments where information is extracted with regards to ESG scoring, the present invention can ensure that the information extracted is relevant for the topic of ESG scoring rather than general as existing OIE systems would give.

Embodiments of the present invention can extract information from large amounts of text and can use keywords to focus on what will be extracted. This provides an advancement over existing systems which extract all facts, including irrelevant facts. Embodiments of the present invention use the input of keywords and then extract triples from large amounts of text. Humans are allowed to update the knowledge graph and/or the alias list. Doing so can further improve the system. Embodiments of the present invention allow for the updating of either the knowledge graph or the alias list to further improve performance. Embodiments of the present invention are able to operate on text that contains different sentences containing different locations, and can prune the other locations.

The improvements to existing technology, which can be provided individually or together in various combinations according to different embodiments of the present invention, individually and collectively contribute to a successful collaborative system that is beneficial for end users. The following examples show how certain features of the present invention, which can be provided alone or in various combinations of embodiments, provide improvements:

1) Without using a keyword and context centric approach, OpenKG creation will result in a knowledge graph that is constructed based on the entire textual information in the input corpus, therefore the knowledge graph will be unnecessarily big and contain information irrelevant for the input keywords;
2) Not utilizing the iterative alias expansion and query generation step could result in a knowledge graph that is missing triples which are relevant for the input query;
3) Not including alias information during the OpenKG extraction could mean that the extraction is only conditioned on the word appearing in the sentence and not any other possible synonym, which could make the extraction of the other triple parts less accurate and meaningful; and
4) Omitting the OpenKG pruning step could result in a knowledge graph that has too many redundant triples.

An embodiment of the present invention could include the following exemplary components:

1) Alias expansion and query generation: A dependency parser. Dependency parsers generate syntactic structure of natural language sentences. Any pre-trained dependency parser can be used. When such dependency parsing structure is provided, certain “typed dependencies” can be used (e.g., nsubj—indicating nominal subject of the sentence, see, e.g., de Marneffe, Marie-Catherine, et al., “Stanford typed dependencies manual,” Stanford Parser 3.7.0, pp. 1-28 (September 2016), which is hereby incorporated by reference herein).
2) OpenKG extractor module: Modular and iterative multilingual open information extraction (MILLIE) with an extension to accept locations and time (see, e.g., Kotnis, Bhushan, et al., “Integrating diverse extraction pathways using iterative predictions for Multilingual Open Information Extraction,” Computation and Language, arXiv:2110.08144v1, pp. 1-11 (Oct. 15, 2021), and U.S. application Ser. No. 17/342,575, each of which is hereby incorporated by reference herein.
3) Pruning strategies: For each strategy type there is at least one possible instantiation available or implemented.
4) Classification: Next sentence prediction (NSP) or KBlrn.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for automated decision making in an artificial intelligence task by fact-relevant open information extraction and knowledge graph generation, the method comprising:
obtaining a keyword query for performing the fact-relevant open information extraction;
expanding the keyword query using keyword alias and query generation;
performing the fact-relevant open information extraction to extract triples from a text which contains the keyword or the keyword alias;
generating the knowledge graph using the extracted triples using an open knowledge graph (OpenKG) extractor that has been trained using keywords and aliases; and
performing supervised or unsupervised classification and the generated knowledge graph to make the automated decision in the artificial intelligence task.

2. The method according to claim 1, further comprising obtaining a context query, expanding the context query using context alias and query generation, and performing the fact-relevant open information extraction to extract the triples from the text which contain the context or the context alias, and the keyword or the keyword alias.

3. The method according to claim 2, further comprising displaying the aliases and queries to a user, and updating the aliases and/or the queries based on a user input.

4. The method according to claim 1, further comprising displaying the knowledge graph to a user, and pruning the knowledge graph based on a user input.

5. The method according to claim 1, further comprising pruning the generated knowledge graph by at least one of temporal, location or triple pruning.

6. The method according to claim 1, wherein the keyword query is obtained from a recommendation system.

7. The method according to claim 1, wherein the supervised classification is performed using a Gumbel softmax.

8. The method according to claim 1, wherein the unsupervised classification is performed using a relational page rank algorithm.

9. The method according to claim 1, wherein the OpenKG extractor has been trained using different keywords and context from a different source text, wherein each of the keywords and the respective context are combined at nodes in the knowledge graph.

10. The method according to claim 1, wherein the automated decision includes one of adapting parameters of a device or digital display, or manufacturing or providing instructions for manufacturing of a product.

11. A system for automated decision making in an artificial intelligence task by fact-relevant open information extraction and knowledge graph generation, the system comprising one or more hardware processors configured, alone or in combination, to provide for execution of the following steps:
obtaining a keyword query for performing the fact-relevant open information extraction;
expanding the keyword query using keyword alias and query generation;
performing the fact-relevant open information extraction to extract triples from a text which contains the keyword or the keyword alias;
generating the knowledge graph using the extracted triples and an open knowledge graph (OpenKG) extractor that has been trained using keywords and aliases; and
performing supervised or unsupervised classification using the generated knowledge graph to make the automated decision in the artificial intelligence task.

12. The system according to claim 11, being further configured to obtain a context query, expand the context query using context alias and query generation, and perform the fact-relevant open information extraction to extract the triples from the text which contain the context or the context alias, and the keyword or the keyword alias.

13. The system according to claim 11, wherein the OpenKG extractor has been trained using different keywords and context from a different source text, wherein each of the keywords and the respective context are combined at nodes in the knowledge graph.

14. The system according to claim 11, wherein the automated decision includes one of adapting parameters of a device or digital display, or manufacturing or providing instructions for manufacturing of a product.

15. A tangible, non-transitory computer-readable medium having instructions thereon, which, upon being executed by one or more processors provide for execution of the following steps:
obtaining a keyword query for performing the fact-relevant open information extraction;
expanding the keyword query using keyword alias and query generation;
performing the fact-relevant open information extraction to extract triples from a text which contains the keyword or the keyword alias;
generating the knowledge graph using the extracted triples and an open knowledge graph (OpenKG) extractor that has been trained using keywords and aliases; and
performing supervised or unsupervised classification using the generated knowledge graph to make the automated decision in the artificial intelligence task.
